(19) United States
(12) Patent Application Publication
(10) Pub. No.: US 2013/0055364 A1
(43) Pub. Date: Feb. 28, 2013

(54) INFORMATION PROCESSING APPARATUS, METHOD FOR CONTROLLING THE SAME AND STORAGE MEDIUM

(71) Applicant: Masamichi Tanji, Kawasaki-shi (JP)

(72) Inventor: Masamichi Tanji, Kawasaki-shi (JP)

(73) Assignee: CANON KABUSHIKI KAISHA, Tokyo (JP)

(21) Appl. No.: 13/566,946

(22) Filed: Aug. 3, 2012

(30) Foreign Application Priority Data
Aug. 30, 2011 (JP) 2011-187855

(51) Int. Cl. G06F 15/167; G06F 21/20

(52) U.S. Cl. 726/5; 709/213

(57) ABSTRACT

An information processing apparatus of this invention has a function of transmitting data to a server on a network and causing the server to store the data. Setting information including at least the validated period information of the data and the storage destination information of the server is stored. The information processing apparatus instructs the server to delete the data stored even after the elapse of a validated period represented by the validated period information based on the stored validated period information and the storage destination information of the server.

### BACKGROUND OF THE INVENTION

1. Field of the Invention

The present invention relates to an information processing apparatus that has a function of transmitting data of, for example, a scanned image to a server on a network to store the data in it and automatically deletes the data stored in the server, a method for controlling the same, and a storage medium.

2. Description of the Related Art

In recent years, a cloud computing system has become popular as a form for allowing a server to manage business data and execute various kinds of processing. Under the circumstances, an MFP (Multi Function Peripheral) has came along that has a function for transmitting and uploading data of a scanned image or the like to a file server on a cloud. When a user inputs authentication information to the MFP to access the file server on the cloud, the MFP logs in to the file server using the authentication information. The user can thus allow desired data to be transmitted from the MFP to a predetermined directory on the file server. This function allows a plurality of persons to access the file server on the cloud and refer to or obtain the data irrespective of the place.

On the other hand, keeping the data in the file server on the cloud forever may be undesirable from the viewpoint of security or the like. Hence, there is a demand for keeping the data in the server only for a necessary period and deleting it when due. To meet this requirement, the user who has updated the data may delete the transmitted data by himself/herself at a desired timing. In this case, the user needs to input the authentication information again from an MFP, a PC, or the like to log in to the file server each time he/she wants to delete the data.

In addition, frequently executing data delete puts heavy operation load on the user. If the user forgets to delete, the data is kept uploaded indefinitely. To prevent this, for example, the server side may have a function of automatically deleting the data after the elapse of a predetermined period. There has been proposed, as such an idea, an automatic file deleting apparatus for automatically deleting a file after the elapse of a predetermined time from its final update time (Japanese Patent Laid-Open No. 7-225704).

However, the related art has no flexibility because the period for which data can be stored in the server is equally set for every data. Hence, the method is not a drastic solution if the period the user wants to store data changes between data. In addition, when the user stores data in a server that provides no automatic delete function, he/she needs to manually instruct deletion as before. Furthermore, it is cumbersome for the user to input authentication information from an MFP, a PC, or the like to log in to the server each time to delete data.

### SUMMARY OF THE INVENTION

In order to solve the problems of the above-described related art, the present invention provides a technique of causing an information processing apparatus having a function of transmitting data to a server and storing the data in it to delete the data stored in the server when a set validated period has elapsed.

According to one aspect of the present invention, there is provided an information processing apparatus having a function of transmitting data to a server on a network and causing the server to store the data, comprising: a storage unit configured to store setting information including at least validated period information of the data and storage destination information of the server; and a delete unit configured to instruct the server to delete the data stored even after an elapse of a validated period represented by the validated period information based on the validated period information and the storage destination information of the server stored in the storage unit.

According to another aspect of the present invention, there is provided a method for controlling an information processing apparatus having a function of transmitting data to a server on a network and causing the server to store the data, comprising: storing setting information including at least validated period information of the data and storage destination information of the server in a storage unit; and instructing the server to delete the data stored even after an elapse of a validated period represented by the validated period information based on the validated period information and the storage destination information of the server stored in the storage unit.

According to the present invention, it is possible to cause an information processing apparatus having a function of transmitting data to a server and storing the data in it to delete the data stored in the server when a set validated period has elapsed. Even before the elapse of the validated period, desired data can be deleted by a simple operation.

Further features of the present invention will become apparent from the following description of exemplary embodiments (with reference to the attached drawings).

### BRIEF DESCRIPTION OF THE DRAWINGS

FIG. 1 is a block diagram showing the hardware arrangement of a network system and an image forming apparatus according to the first embodiment;

FIG. 2 is a block diagram showing the software configuration of the image forming apparatus according to the first embodiment;

FIG. 3 is a view showing an example of the authentication setting UI of a UI control unit according to the first embodiment;

FIG. 4 is a view showing an example of the scan setting screen of the UI control unit according to the first embodiment;

FIG. 5 is a flowchart for explaining an example of scan processing of the image forming apparatus according to the first embodiment;

FIG. 6 is a table showing an example of transmission file information according to the first embodiment;

FIG. 7 is a flowchart showing an example of automatic transmission data delete processing of the image forming apparatus according to the first embodiment;

FIG. 8 is a table showing an example of transmission file information by an image forming apparatus according to the second embodiment;

FIG. 9 is a view showing an example of a transmission history list screen according to the second embodiment;

FIG. 10 is a flowchart for explaining transmission history list display processing when the image forming apparatus according to the second embodiment displays the transmission history list screen on an operation panel; and

FIG. 11 is a flowchart for explaining transmission data delete processing when a user has pressed a delete button on the image forming apparatus according to the second embodiment.

### DESCRIPTION OF THE EMBODIMENTS

Hereinafter, embodiments of the present invention will be described in detail with reference to the accompanying drawings. It should be noted that the following embodiments are not intended to limit the scope of the appended claims, and that not all the combinations of features described in the embodiments are necessarily essential to the solving means of the present invention. In the following embodiments, an image forming apparatus 100 will be described as an example of an information processing apparatus of the present invention. However, the information processing apparatus of the present invention is not limited to such an image forming apparatus.

### First Embodiment

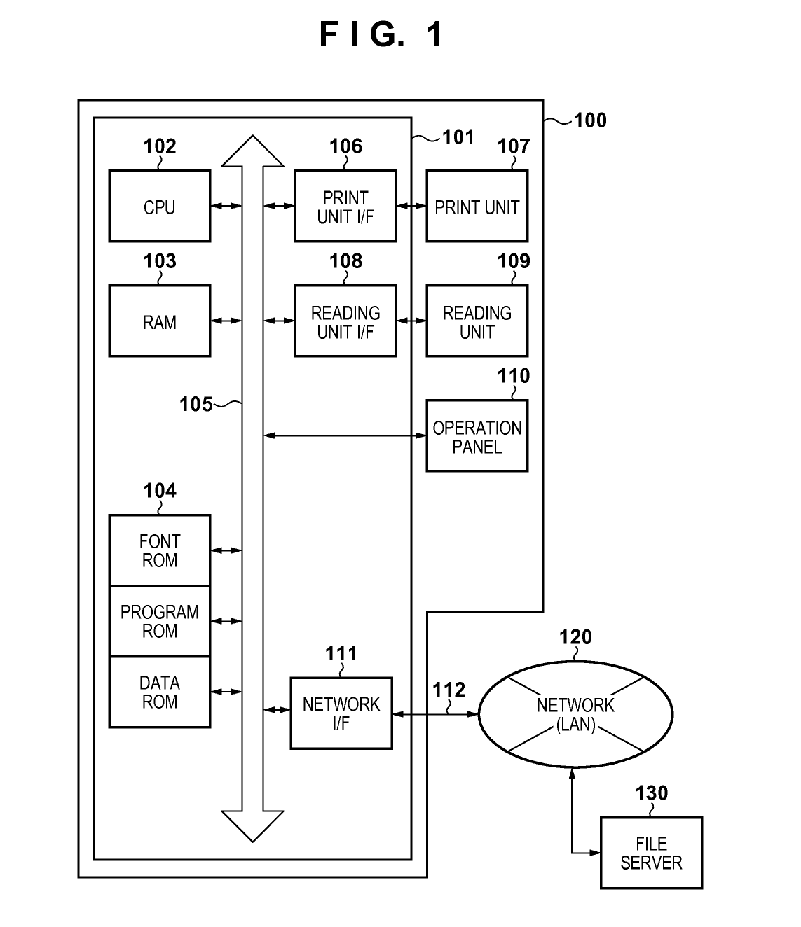

FIG. 1 is a block diagram showing the hardware arrangement of a network system and the image forming apparatus 100 according to the first embodiment of the present invention.

The image forming apparatus 100 includes a print unit 107, a reading unit 109, an operation panel 110, and a control unit 101 for controlling them. The control unit 101 includes a CPU 102, a RAM 103, a ROM 104, a print unit I/F 106, a reading unit I/F 108, and a network I/F 111. These units are connected to each other via a system bus 105. The CPU 102 generally controls these units based on various kinds of control programs. The various kinds of control programs are stored in the program ROM of the ROM 104, and read out and executed by the CPU 102. Alternatively, the various kinds of control programs are stored in the program ROM of the ROM 104 as compressed data. The programs are decompressed and then expanded and executed on the RAM 103. The above-described various kinds of control programs may be stored in a hard disk drive (HDD) (not shown) in a compressed or non-compressed state.

The network I/F 111 communicates with a file server 130 on a network via a network (LAN) 120 or the like. The network I/F 111 and the network 120 are connected via a communication cable such as a LAN cable 112. The print unit I/F 106 serves as an interface to output an image signal to the print unit 107 (printer engine).

The reading unit I/F 108 serves as an interface to receive an image signal obtained by causing the reading unit 109 (scanner engine) to read an image on a document. The CPU 102 processes the image signal received from the reading unit I/F 108 and outputs it to the print unit I/F 106 as image data to be printed. Alternatively, the CPU 102 processes the image signal received from the reading unit I/F 108 and transmits it to the file server 130 on the LAN 120 via the network I/F 111 as image data to be stored.

The CPU 102 displays characters and symbols on the display unit of the operation panel 110 using font information stored in the font ROM of the ROM 104, or receives instruction information from the operation panel 110 that has received a user instruction. The data ROM of the ROM 104 stores device information of the image forming apparatus 100, user's telephone directory information, department management information, and the like. These pieces of information are read out by the CPU 102 as needed and updated as needed.

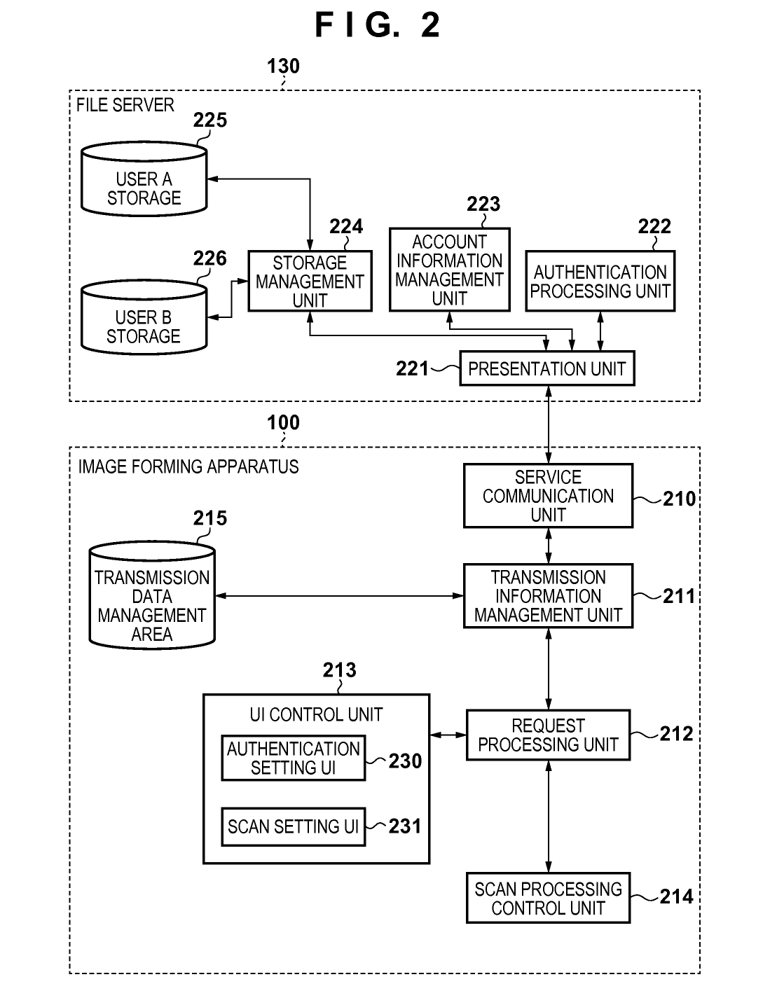

FIG. 2 is a block diagram showing the software configuration of the image forming apparatus 100 and the file server 130 according to this embodiment. The functional units shown in FIG. 2 are implemented by causing the CPU 102 included in the image forming apparatus 100 and a CPU (not shown) included in the file server 130 to execute the control programs.

The image forming apparatus 100 includes a service communication unit 210, a transmission information management unit 211, a request processing unit 212, a UI control unit 213, a scan processing control unit 214, and a transmission data management area 215.

The service communication unit 210 communicates with a presentation unit 221 of the file server 130. The contents of the request (processing request) to the presentation unit 221 at this time represent authentication processing, transmission data upload, or the like, which is decided based on the transmission contents from the request processing unit 212. The service communication unit 210 also analyzes the response from the presentation unit 221 and transmits a processing result for the request to the request processing unit 212. Note that the service communication unit 210 is assumed to control communication processing in an application layer that changes between services. For example, the service communication unit 210 is assumed to perform communication processing with a service implemented by a Web service such as SOAP or REST implemented using a communication protocol HTTP or the like. This allows the image forming apparatus 100 to use a service provided by the file server 130, such as authentication or transmission data transmission to the file server 130.

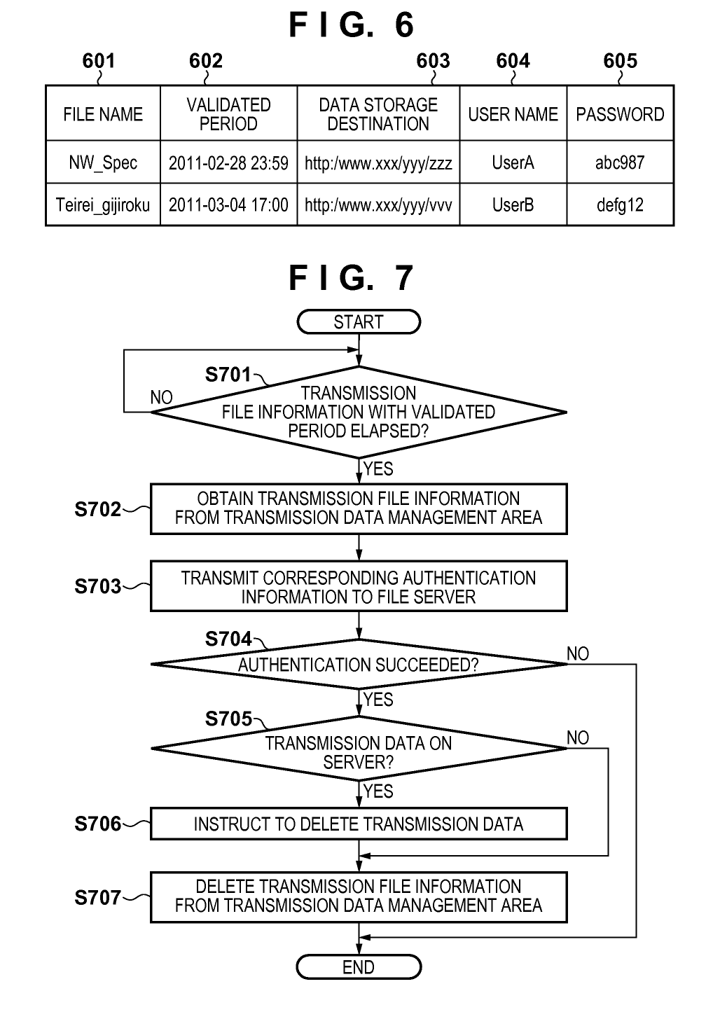

The request processing unit 212 analyzes user input information transmitted from the UI control unit 213 and sends various kinds of instructions to the service communication unit 210, the transmission information management unit 211, and the scan processing control unit 214. For example, upon receiving authentication information or scan setting information transmitted from the UI control unit 213, the request processing unit 212 transmits the information to the transmission information management unit 211 and request management processing as transmission file information. Note that the transmission file information will be described later with reference to FIG. 6. The request processing unit 212 also transmits authentication information to the service communication unit 210 and requests communication for authentication processing. Alternatively, the request processing unit 212 transmits scan setting information to the scan processing control unit 214 to request scan execution by the reading unit 109. After that, the request processing unit 212 transmits transmission data (image data) received as the product of scan execution to the service communication unit 210 and requests communication to upload the data. As described above, the request processing unit 212 decides the request destination in accordance with the transmission contents from the service communication unit 210 and the UI control unit 213 and outputs an instruction to the decided request destination.

The transmission information management unit 211 generates transmission data from the authentication information or scan setting information transmitted from the request processing unit 212, and holds the data in the transmission data management area 215.

The UI control unit 213 controls a UI to be displayed on the operation panel 110 of the image forming apparatus 100 in accordance with a request from the request processing unit 212. More specifically, upon receiving an authentication screen display request, the UI control unit 213 displays an authentication setting UI 230 on the operation panel 110. When the user of the image forming apparatus 100 inputs an authentication setting (authentication information), the UI control unit 213 obtains the authentication information and transmits it to the request processing unit 212. Upon receiving a scan setting screen display request from the request processing unit 212 as well, the UI control unit 213 displays a scan setting UI 231 on the operation panel 110.

The scan processing control unit 214 obtains scan setting information from the request processing unit 212 and requests the reading unit 109 to perform scan based on the setting information. The scan processing control unit 214 performs file conversion of scan data to generate transmission data (image file) and transmits the transmission data to the request processing unit 212.

The file server 130 includes the presentation unit 221, an authentication processing unit 222, an account information management unit 223, a storage management unit 224, a user A storage 225, and a user B storage 226.

The presentation unit 221 communicates with the service communication unit 210 of the image forming apparatus 100 and transmits, in response to a processing request from the image forming apparatus 100, a processing result to the service communication unit 210 of the image forming apparatus 100. At this time, the presentation unit 221 switches the processing request destination in accordance with the processing request transmitted from the service communication unit 210. When requested to perform authentication processing, the presentation unit 221 obtains authentication information and requests authentication processing of the authentication processing unit 222. The presentation unit 221 also transmits the result to the service communication unit 210. When requested to change account information, the presentation unit 221 obtains account information and requests change processing of the account information management unit 223. The presentation unit 221 also transmits the result to the service communication unit 210. When requested to do upload to a storage area, the presentation unit 221 obtains data and storage destination information and requests storage processing of the storage management unit 224.

The authentication processing unit 222 performs authentication processing based on authentication information obtained from the presentation unit 221. The authentication processing unit 222 also transmits the authentication result to the presentation unit 221. The presentation unit 221 then transmits it to the image forming apparatus 100. The account information management unit 223 performs account information change processing based on account information obtained from the presentation unit 221. The account information management unit 223 also transmits the change result to the presentation unit 221. The presentation unit 221 then transmits it to the image forming apparatus 100. The storage management unit 224 performs storage processing in a storage area based on data and its storage destination information obtained from the presentation unit 221. The storage management unit 224 also transmits the storage result to the presentation unit 221. The presentation unit 221 then transmits it to the image forming apparatus 100.

The user A storage 225 and the user B storage 226 are the storage areas of the file server 130, which are allocated in a storage device (not shown) such as an HDD included in the file server 130. In this example, only two storage areas exist. However, there are storage areas as many as the accounts managed by the file server 130. The storage management unit 224 deletes files in the storage areas or uploads files to the storage areas. The user A storage 225 and the user B storage 226 return the upload result to the storage management unit 224. If an area to store a file requested to be uploaded does not exist, an error is returned.

Note that in this example, the file server 130 provides the file management service by itself. However, as another form of the file server 130, a plurality of servers may be provided, and a plurality of virtual machines are activated in the server group to perform distributed processing. In this case, a technique called scale out (cloud computing) for increasing the virtual machines in accordance with a predetermined condition is used.

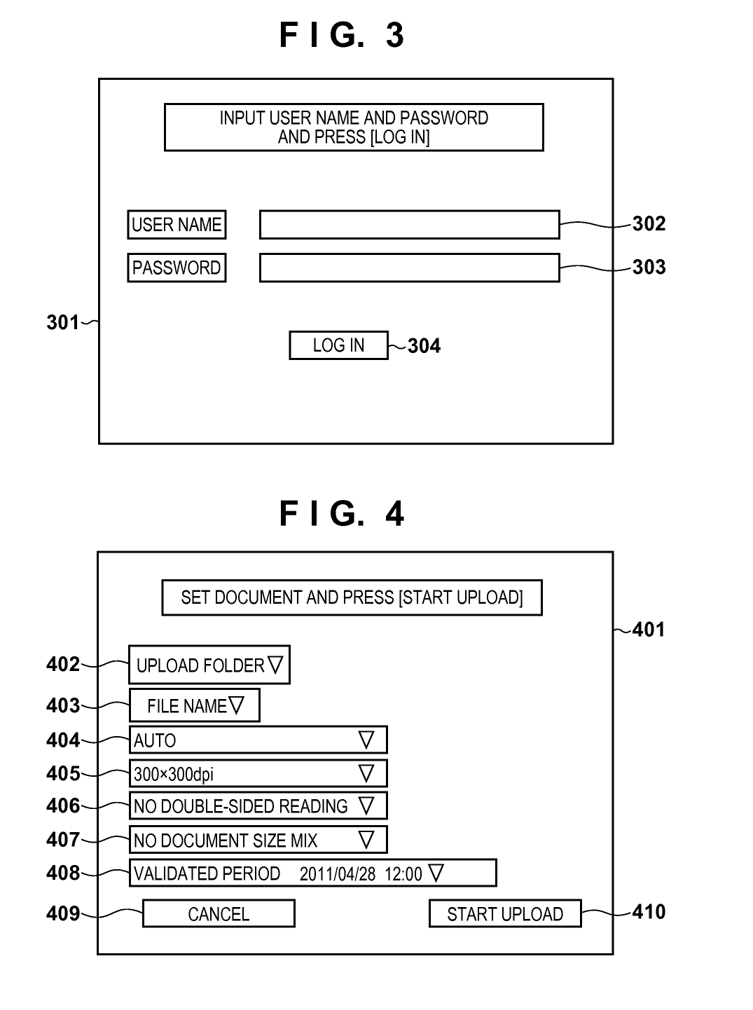

FIG. 3 is a view showing an example of the authentication setting UI of the UI control unit 213 according to this embodiment.

The UI control unit 213 displays a screen based on a response received from the file server 130, as indicated by a content display area 301 of the operation panel 110. FIG. 3 shows a result obtained when the request processing unit 212 requests the UI control unit 213 to display the authentication setting UI 230, and the UI control unit 213 then displays the authentication setting UI 230 on the operation panel 110 of the image forming apparatus 100. This screen includes a user name input field 302 and a password input field 303. The user of the image forming apparatus 100 inputs the user name to the input field 302 and the password to the input field 303. The service communication unit 210 thus performs authentication for the file server 130. When the user inputs the user name and the password to the input fields and presses a login button 304, the service communication unit 210 obtains the information (login information) input to the user name input field 302 and the input field 303 from the UI control unit 213 and performs authentication for the file server 130.

FIG. 4 is a view showing an example of the scan setting screen of the UI control unit 213 according to this embodiment.

The UI control unit 213 displays a UI screen in a content display area 401 of the operation panel 110 based on a response received from the file server 130. FIG. 4 shows a result obtained when the request processing unit 212 requests the scan setting UI 231 of the UI control unit 213, and the UI control unit 213 then displays the scan setting UI 231 on the operation panel 110 of the image forming apparatus 100. When the user presses an upload folder select button 402, the file arrangement of the account in the file server 130 is displayed. The user of the image forming apparatus 100 thus selects the folder of the upload destination using the screen. The user of the image forming apparatus 100 also inputs a file name to a file name input field 403, thereby causing the file server 130 to confirm the name of the file to be uploaded.

A button 404 is a select button to set the reading mode. In FIG. 4, “auto” is selected to automatically set the reading mode. A button 405 is used to select the resolution of read image data. A button 406 is used to select reading of both surfaces of a document. A button 407 is used to select whether to mix the document sizes. A field 408 is a validated period input field. When the validated period set here has been reached, the image forming apparatus 100 executes automatic transmission data delete processing according to the embodiment to be described later.

When the user presses a cancel button 409, the scan setting screen is closed, and the scan upload processing is canceled. When the user presses an upload start button 410, the service communication unit 210 obtains the values input using the upload folder select button 402, the file name input field 403, the scan setting buttons 404 to 407, and the validated period input field 408 from the UI control unit 213 as scan setting information. After the document is scanned in accordance with the scan setting information, the service communication unit 210 uploads the transmission data to the file server 130.

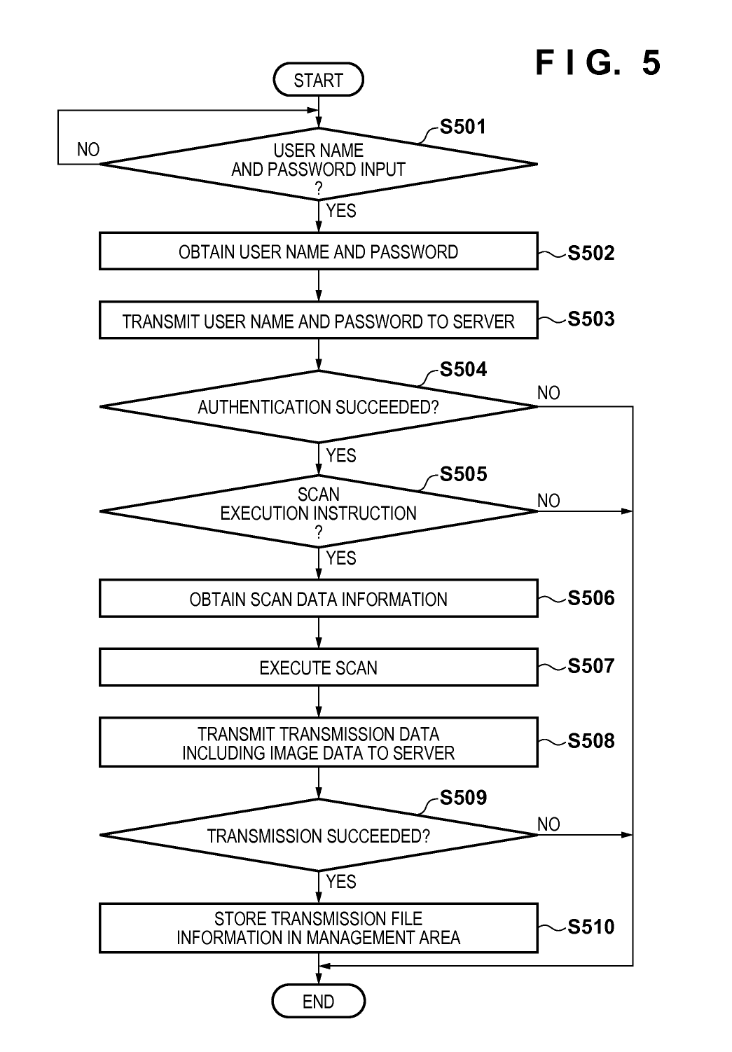

FIG. 5 is a flowchart for explaining an example of scan processing of the image forming apparatus 100 according to this embodiment. Referring to FIG. 5, steps 5501 to 5510 represent process steps which correspond to the procedure of scan processing executed by the image forming apparatus 100. Note that the program to execute the steps is stored in one of the RAM 103, the ROM 104, and the hard disk drive (HDD) (not shown) and executed under the control of the CPU 102.

In step S501, the UI control unit 213 of the image forming apparatus 100 waits until the user inputs the user name and the password via the authentication setting UI 230 shown in FIG. 3. When the user name and the password are input, the process advances to step S502. The transmission information management unit 211 obtains authentication information including these pieces of information via the request processing unit 212 and temporarily holds it. The transmission information management unit 211 also provides the obtained authentication information to the service communication unit 210. The process advances to step S503, and the service communication unit 210 transmits the authentication information including the user name and the password obtained in step S502 to the presentation unit 221 of the file server 130 and performs authentication for the file server 130. In step S504, the service communication unit 210 determines whether a response of authentication success has been received from the presentation unit 221 of the file server 130. If the authentication has failed, the scan processing does not continue but immediately ends.

On the other hand, if the authentication has succeeded, the process advances to step S505 and the UI control unit 213 waits for scan request input via the scan setting UI 231 shown in FIG. 4. When the user presses the cancel button 409, this flowchart immediately ends.

When the user presses the upload start button 410 shown in FIG. 4 to input a scan execution instruction in step S505, the process advances to step S506. In step S506, the transmission information management unit 211 obtains scan setting information including the input values of the scan setting menu items 402 to 408 of the scan setting UI 231 shown in FIG. 4 via the request processing unit 212 and temporarily holds it.

The process advances to S507. The scan processing control unit 214 requests scan of the reading unit 109 based on the scan setting information from the request processing unit 212, and performs file conversion of image data obtained by reading to generate transmission data including the image data. When the transmission data is created, the process advances to step S508, and the service communication unit 210 transmits the transmission data to the presentation unit 221 of the file server 130. The process advances to step S509, and the service communication unit 210 determines the transmission data transmission result. Upon determining that the transmission has failed, the flowchart immediately ends.

On the other hand, upon determining in step S509 that the transmission has succeeded, the process advances to step S510. The transmission information management unit 211 stores the authentication information obtained in step S503, the scan setting information obtained in step S506, and the transmission file information in the transmission data management area 215. After the above-described processing has been executed, the image forming apparatus 100 (CPU 102) ends the flowchart.

With the above-described processing, the image forming apparatus 100 executes document reading in accordance with an instruction of the user of the image forming apparatus 100, who has successfully been authenticated, and transmits the read data to the file server 130. The image forming apparatus 100 can store the authentication information, the scan setting information, and the transmission file information.

FIG. 6 is a table showing an example of transmission file information according to this embodiment.

The transmission file information includes a file name 601, a validated period 602, a data storage destination 603, a user name 604, and a password 605. The file name 601 stores a file name input to the file name input field 403 shown in FIG. 4. The validated period 602 stores validated period information input to the validated period input field 408. The data storage destination 603 stores a folder path of the file server 130 selected by the upload folder select button 402. The user name 604 stores a user name input to the user name input field 302 shown in FIG. 3. The password 605 stores a password input to the password input field 303.

As an example, FIG. 6 shows a state in which a piece of transmission file information exists for each of a user A (userA) and a user B (userB).

FIG. 7 is a flowchart showing an example of automatic transmission data delete processing of the image forming apparatus 100 according to this embodiment. Steps S701 to S707 represent process steps which correspond to the procedure of automatic transmission data delete processing executed by the image forming apparatus 100. Note that the program to execute the control procedure corresponding to the steps is stored in one of the RAM 103, the ROM 104, and the hard disk drive (HDD) (not shown) and executed under the control of the CPU 102.

In step S701, the transmission information management unit 211 polls the contents of the transmission data management area 215 at a predetermined interval and determines whether transmission file information whose validated period has elapsed exists. Upon determining that transmission file information whose validated period has elapsed exists, the process advances to step S702. The transmission information management unit 211 obtains the transmission file information from the transmission data management area 215. The process advances to step S703, and the service communication unit 210 transmits authentication information to the presentation unit 221 of the file server 130 and performs authentication for the file server 130. Note that the authentication information transmitted by the service communication unit 210 at this time includes the user name 604 and the password 605 stored in the transmission file information obtained by the transmission information management unit 211 in step S702. In step S704, the service communication unit 210 determines whether a response of authentication success has been received from the presentation unit 221 of the file server 130. Upon determining that the authentication has failed, this flowchart immediately ends.

On the other hand, if the authentication has succeeded, the process advances to step S705. The transmission information management unit 211 determines whether a file (data) having the same name as the file name 601 exists on the folder path of the file server 130 stored in the data storage destination 603 of the transmission file information. Upon determining that a file having the same name exists, the process advances to step S706. The transmission information management unit 211 sends, via the service communication unit 210, an instruction (delete instruction) to the file server 130 to delete the file. The process advances to step S707, and the transmission information management unit 211 deletes the transmission file information stored in the transmission data management area 215. On the other hand, upon determining in step S705 that no file having the same name exists, the transmission information management unit 211 immediately deletes the transmission file information in the transmission data management area 215. After the above-described processing has been executed, the flowchart ends.

As described above, according to the first embodiment, transmission data uploaded from the image forming apparatus 100 to the server 130 can automatically be deleted without labor based on validated period information set in the transmission file information of each transmission data.

In addition, this automatic delete processing can be implemented independently of the function of the server 130. It is therefore possible to apply the automatic delete processing even in an environment where the automatic delete function is not provided as a function of the server 130. Furthermore, the image forming apparatus holds the authentication information input by the user at the time of scan execution. This saves the user from having to input the authentication information again to delete data uploaded to the server 130.

### Second Embodiment

The second embodiment of the present invention will be described next. Note that the arrangements of an image forming apparatus 100 and a server 130 and the system arrangement according to the second embodiment are the same as in the above-described first embodiment, and a description thereof will be omitted.

In the second embodiment, the image forming apparatus 100 displays a transmission history list screen on an operation panel 110 so that data after the validated period can immediately be deleted from the screen based on a user instruction.

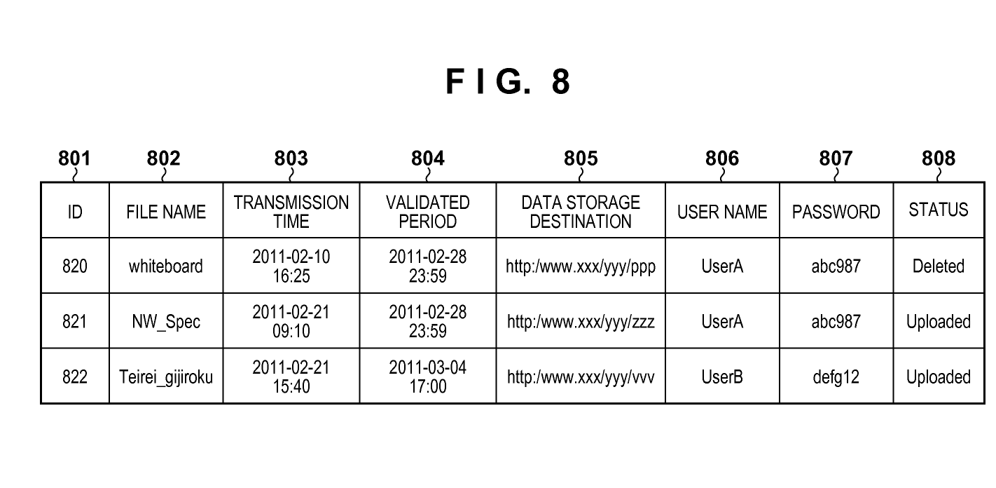

FIG. 8 is a table showing an example of transmission file information by the image forming apparatus 100 according to the second embodiment of the present invention.

The transmission file information includes an ID 801, a file name 802, a transmission time 803, a validated period 804, a data storage destination 805, a user name 806, a password 807, and a status 808. The ID 801 is an ID number that is automatically added by a transmission information management unit 211 upon executing scan processing to uniquely identify transmission data. The file name 802 stores a file name input to a file name input field 403. The transmission time 803 stores a time when transmission data has successfully transmitted in the scan processing shown in FIG. 5. The validated period 804 stores validated period information input to a validated period input field 408. The data storage destination 805 stores the file name and folder path of the file server 130 selected by an upload folder select button 402.

The user name 806 stores a user name input to a user name input field 302. The password 807 stores a password input to a password input field 303. The status 808 stores the current status information of transmission data. For example, when transmission data remains uploaded in the file server 130 because the validated period has not elapsed yet, “Uploaded” is stored as the status information. On the other hand, if transmission data has already been deleted from the file server 130 because of the elapse of the validated period or the like, “Deleted” is stored as the status information.

As an example, FIG. 8 shows a state in which a total of three pieces of transmission file information exist for a user A (userA) and a user B (userB). Data of an ID “820” is transmission data of the user A which has already been deleted from the file server 130. Data of an ID “821” is transmission data of the user A which remains uploaded in the file server 130 because the validated period has not elapsed yet. Data of an ID “822” is transmission data of the user B which remains uploaded in the file server 130 because the validated period has not elapsed yet.

In this embodiment, the pieces of transmission file information shown in FIG. 8 are assumed to be stored in a transmission data management area 215.

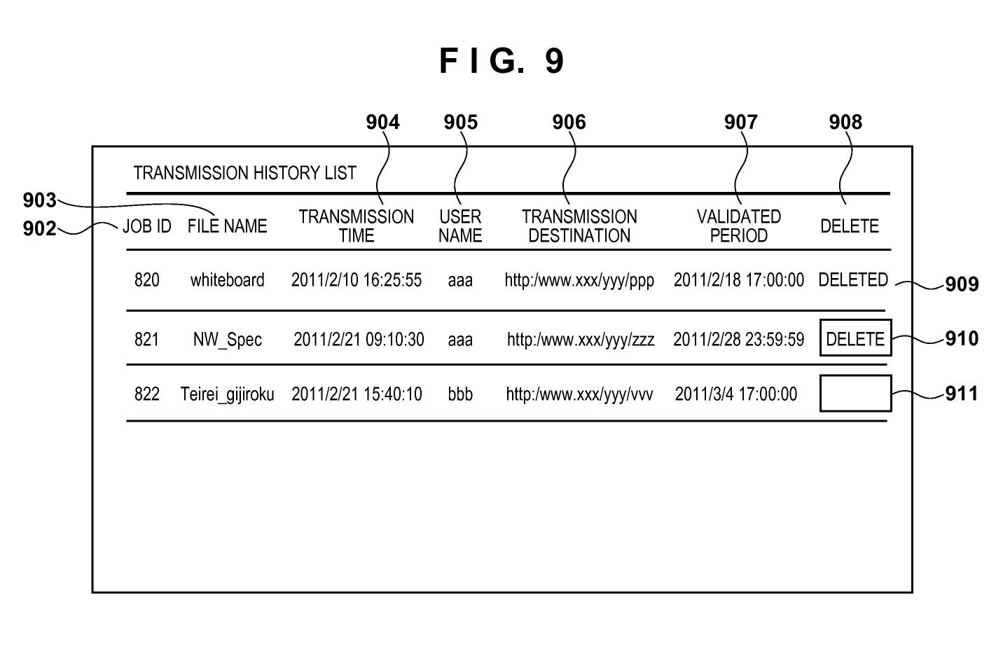

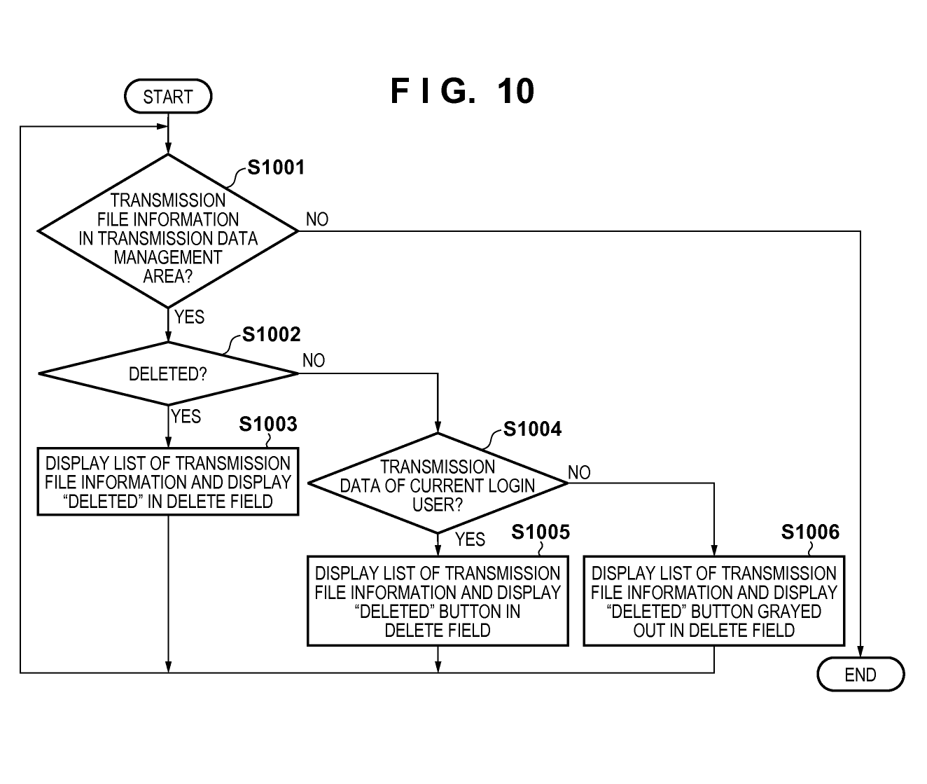

FIG. 9 is a view showing an example of a transmission history list screen according to the second embodiment.

This transmission history list screen is displayed on the operation panel 110 in accordance with a display request from the user after login from an authentication setting UI 230 of a UI control unit 213. In FIG. 9 of this embodiment, assume that the user A logs in to the image forming apparatus 100 and inputs the display request for the transmission history list screen from the operation panel 110. In this case, the user A cannot delete the files of other users except the files of his/her own in the state shown in FIG. 9.

The transmission history list screen includes the items of a job ID 902 of a job issued to a user, a file name 903, a transmission time 904, a user name 905, a transmission destination 906, a validated period 907, and delete 908. The job ID 902 displays the IDs of the ID 801 shown in FIG. 8. The file name 903 displays the contents of the file name 802. Similarly, the transmission time 904 displays the contents of the transmission time 803, the user name 905 displays the contents of the user name 806, the transmission destination 906 displays the contents of the data storage destination 805, and the validated period 907 displays the contents of the validated period 804. The delete 908 involves display a status corresponding to the contents of the user name 806 and the status 808.

The data of the job ID “820” has already been deleted from the file server 130, as described above with reference to FIG. 8. For this reason, “deleted” 909 is displayed in the item of the delete 908 for the job ID “820”. The data of the job ID “821” is transmission data of the current login user A of the image forming apparatus 100, and remains uploaded in the file server 130. Hence, a delete button 910 indicating that the data of the job ID “821” can be deleted is displayed in the delete 908. The data of the job ID “822” also remains uploaded in the file server 130, though it is not transmission data of the user A. For this reason, a delete button 911 in the delete 908 is grayed out to disable the delete instruction by the user A.

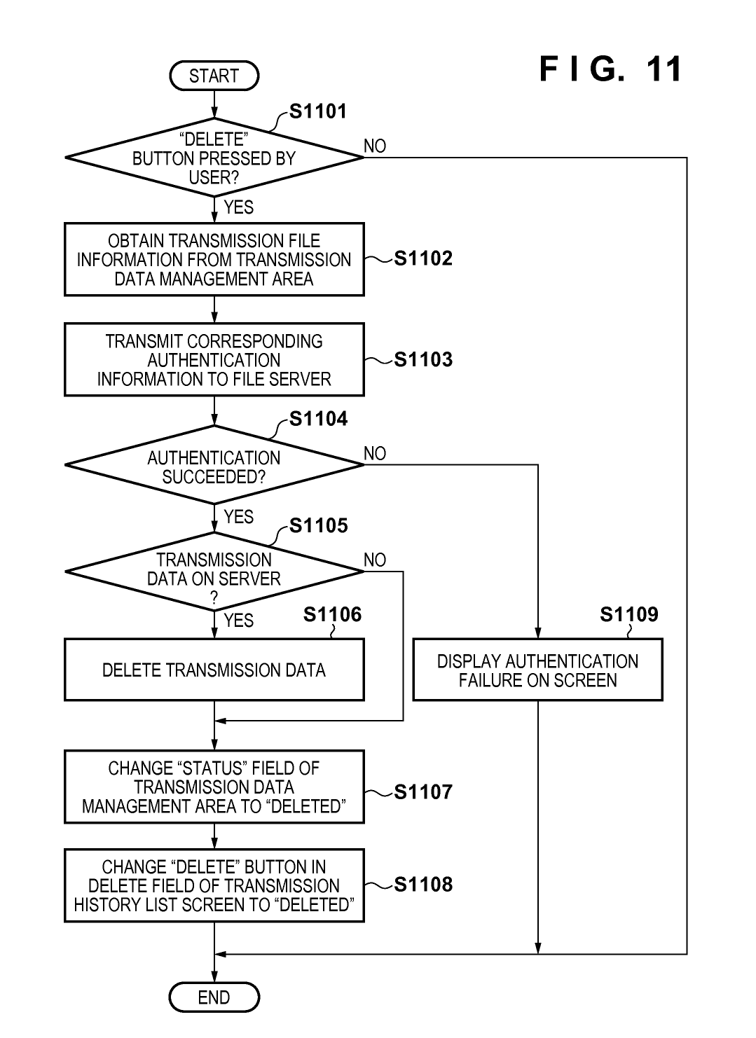

FIG. 10 is a flowchart for explaining transmission history list display processing when the image forming apparatus 100 according to the second embodiment of the present invention displays the transmission history list screen shown in FIG. 9 on the operation panel 110. Steps S1001 to S1006 represent process steps which correspond to the procedure of transmission history list screen display processing when the user who has logged in to the image forming apparatus 100 requests history screen display. Note that the program to execute the steps is stored in one of a RAM 103, a ROM 104, and a hard disk drive (HDD) (not shown) and executed under the control of a CPU 102.

This processing starts when the user who has logged in requests to display the history screen. In step S1001, the transmission information management unit 211 determines whether transmission file information is stored in the transmission data management area 215. Upon determining that no transmission file information is stored, this flowchart immediately ends. In this case, only the menu items 902 to 908 are displayed in the transmission history list screen shown in FIG. 9, and a blank is displayed in place of transmission file information.

Upon determining in step S1001 that transmission file information is stored in the transmission data management area 215, the process advances to step S1002. The transmission information management unit 211 obtains the first transmission file information and determines whether the status 808 is “Deleted”. If the transmission file information has already been deleted, the process advances to step S1003. The UI control unit 213 displays the transmission file information in the transmission history list screen and displays a word “deleted” in the corresponding delete 908. The process returns to step S1001, and the transmission information management unit 211 determines whether the next transmission file information is stored in the transmission data management area 215.

If the transmission file information has not been deleted in step S1002, the process advances to step S1004. It is determined by referring to the contents of the user name 806 whether the transmission data is the data of the current login user of the image forming apparatus 100. If the transmission data is the data of the login user, the UI control unit 213 displays the transmission file information in the transmission history list screen and displays the delete button 910 in the corresponding delete 908. The process returns to step S1001, and the transmission information management unit 211 determines whether the next transmission file information is stored in the transmission data management area 215.

On the other hand, if the transmission data is not the data of the login user in step S1004, the process advances to step S1006. The UI control unit 213 displays the transmission file information in the transmission history list screen and displays the delete button grayed out in the corresponding delete 908, as indicated by 911. The process returns to step S1001, and the transmission information management unit 211 determines whether still another transmission file information is stored in the transmission data management area 215.

The processing procedure is repeated in the above-described way until all pieces of transmission file information stored in the transmission data management area 215 are displayed in the transmission history list screen. After that, the flowchart ends.

FIG. 11 is a flowchart for explaining transmission data delete processing when the user has pressed the delete button 910 on the image forming apparatus 100 according to the second embodiment of the present invention. Steps S1101 to S1109 represent process steps which correspond to the procedure of transmission data delete processing when the user who has logged in to the image forming apparatus 100 presses the delete button 910 displayed in step S1005 of FIG. 10. Note that the program to execute the steps is stored in one of the RAM 103, the ROM 104, and the hard disk drive (HDD) (not shown) and executed under the control of the CPU 102.

This processing starts in a state in which the list screen as shown in FIG. 9 is displayed. In step S1101, the UI control unit 213 waits until the user presses the delete button 910. If the user does not press the delete button 910, the flowchart ends without any processing.

When the use presses the delete button 910, the process advances to step S1102. The transmission information management unit 211 obtains corresponding transmission file information from the transmission data management area 215. In this embodiment, the transmission information management unit 211 obtains the transmission file information of the ID “821”. The process advances to step S1103, and a service communication unit 210 transmits authentication information to a presentation unit 221 of the file server 130 and performs authentication for the file server 130. Note that the authentication information transmitted by the service communication unit 210 at this time includes the user name 806 and the password 807 stored in the transmission file information obtained by the transmission information management unit 211 in step S1102. The process advances to step S1104, and the service communication unit 210 determines whether a response of authentication success has been received from the presentation unit 221 of the file server 130. If the authentication has failed, the process advances to step S1109. The UI control unit 213 displays “authentication failure” in a popup screen or the like on the transmission history list screen, and this flowchart ends.

On the other hand, if the authentication has succeeded, the process advances to step S1105 to determine whether a file having the same name as the file name 802 exists on the folder path of the file server 130 stored in the data storage destination 805 of the transmission file information. Upon determining that such a file exists, the process advances to step S1106 to delete the file from the file server 130. The process then advances to step S1107. In step S1107, the transmission information management unit 211 changes the status 808 of the transmission file information in the transmission data management area 215 to “Deleted”. On the other hand, if no file having the same name exists in step S1105, the transmission data does not exist from the beginning. Hence, the process advances to step S1107, and the transmission information management unit 211 immediately changes the status 808 of the transmission file information in the transmission data management area 215 to “Deleted”. The process advances to step S1108, and the UI control unit 213 changes the field of the delete 908 on the transmission history list screen from the delete button 910 to the word “deleted”. Then, the flowchart ends.

As described above, according to the second embodiment, even before the elapse of the validated period, transmission data stored from the image forming apparatus 100 to the file server 130 can be deleted at a timing desired by the user of the transmission data. In addition, transmission data uploaded from the information processing apparatus (image forming apparatus 100) to the cloud server can be deleted at an appropriate timing without labor based on the validated period set for each transmission data.

Furthermore, even when a cloud server that provides no automatic delete function is used, data can be deleted at a timing desired by the user.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-187855, filed Aug. 30, 2011, which is hereby incorporated by reference herein in its entirety.

What is claimed is:

1. An information processing apparatus having a function of transmitting data to a server on a network and causing the server to store the data, comprising:
a storage unit configured to store setting information including at least validated period information of the data and storage destination information of the server; and
a delete unit configured to instruct the server to delete the data stored even after an elapse of a validated period represented by the validated period information based on the validated period information and the storage destination information of the server stored in said storage unit.

2. The apparatus according to claim 1, further comprising a holding unit configured to hold login information to the server, which is input by a user,
wherein if authentication for the server has succeeded based on the login information held by said holding unit, said delete unit instructs the server to delete the data stored even after the elapse of the validated period.

3. The apparatus according to claim 1, wherein
the data is image data obtained by reading an image on a document, and
the setting information further includes at least a file name of the image data.

4. The apparatus according to claim 2, wherein the login information includes a user name and a password.

5. The apparatus according to claim 1, further comprising a display unit configured to display a list of data transmitted to the server so as to identifiably indicate whether each data is deletable,
wherein when a user instructs to delete the deletable data based on the list displayed by said display unit, said delete unit instructs the server to delete the data.

6. The apparatus according to claim 1, further comprising a unit configured to delete the setting information of the data from said storage unit after the data has been deleted from the server in accordance with the instruction of said delete unit.

7. A method for controlling an information processing apparatus having a function of transmitting data to a server on a network and causing the server to store the data, comprising:
storing setting information including at least validated period information of the data and storage destination information of the server in a storage unit; and
instructing the server to delete the data stored even after an elapse of a validated period represented by the validated period information based on the validated period information and the storage destination information of the server stored in the storage unit.

8. A computer-readable storage medium storing a computer program for causing a computer to execute steps of the method for controlling the information processing apparatus according to claim 7.
